(19) United States
(12) Patent Application Publication
(10) Pub. No.: US 2015/0128339 A1
(43) Pub. Date: May 14, 2015

(54) SINK WITH REMOVABLE DIVIDER

(71) Applicant: WENDY WARNER, MIMS, FL (US)

(72) Inventor: WENDY WARNER, MIMS, FL (US)

(21) Appl. No.: 14/077,437

(22) Filed: Nov. 12, 2013

(51) Int. Cl. E03C 1/186; A47J 47/00

(52) U.S. Cl. CPC E03C 1/186; A47J 47/005
USPC 4/514

(57) ABSTRACT

A sink with a removable divider includes a sink body having a lip and a basin. A drain element is provided within the basin at a central location, and the front and rear portions of the sink basin include generally vertical channels. A divider is removably positioned within the channels so as to bisect the basin into two separate compartments. The divider including a pair of articulating drain plugs, each having a shape that approximates one half of the drain element.

### TECHNICAL FIELD

The present invention relates generally to a sink, preferably a kitchen sink that is constructed from a commercially suitable material and having a divider for separating the sink basin into separate compartments.

### BACKGROUND

The statements in this section merely provide background information related to the present disclosure and may not constitute prior art.

Wherever there is a kitchen, you will find a kitchen sink. Kitchen sinks are typically manufactured as add-in sinks which can be installed within a countertop during home construction or remodeling. To this end, kitchen sinks come in a wide variety of materials, shapes and sizes, and typically include either a single basin, or two-basin construction.

Although both the single and double basin varieties have their own strengths and weaknesses, the choice between the two is often a matter of personal choice by the consumer. However, once installed within the countertop the consumer cannot change the design without incurring substantial costs associated with purchasing a replacement sink, removal and installation costs and plumbing expenses. Moreover, when eventually selling the home, there is the possibility that the new homeowner will prefer one variety over the other.

Accordingly, it would be beneficial to provide a sink with a removable divider which can function to selectively operate as both a single and double basin sink, and that does not suffer from the drawbacks of the above noted devices.

### SUMMARY OF THE INVENTION

The present invention is directed to a sink with a removable divider. One embodiment of the present invention can include a sink body having a lip and a basin. A drain element can be provided within the basin at a central location, and the front and rear portions of the sink basin can include generally vertical channels. The sink can also include a divider which can be positioned within the channels so as to bisect the basin into two separate compartments.

Another embodiment of the present invention can include a pair of articulating drain plugs located along the bottom end of the divider and functioning to independently plug the portion of the drain within a particular compartment.

Yet another embodiment of the present invention can include a cutting board which acts as the divider.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exploded parts view of a sink with removable divider that is useful for understanding the inventive concepts disclosed herein.

FIG. 2 is a perspective view of the sink body in accordance with one embodiment of the invention.

FIG. 3A is a perspective view of the removable divider in accordance with one embodiment of the invention.

FIG. 3B is a side view of the removable divider in accordance with one embodiment of the invention.

FIG. 3C is a front view of the removable divider in accordance with one embodiment of the invention.

FIG. 4A is a perspective view of the sink with removable divider in operation, and in accordance with one embodiment of the invention.

FIG. 4B is another perspective view of the sink with removable divider in operation, and in accordance with one embodiment of the invention.

FIG. 4C is yet another perspective view of the sink with removable divider in operation, and in accordance with one embodiment of the invention.

FIG. 4D is a side perspective view of the sink with removable divider, in accordance with another embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

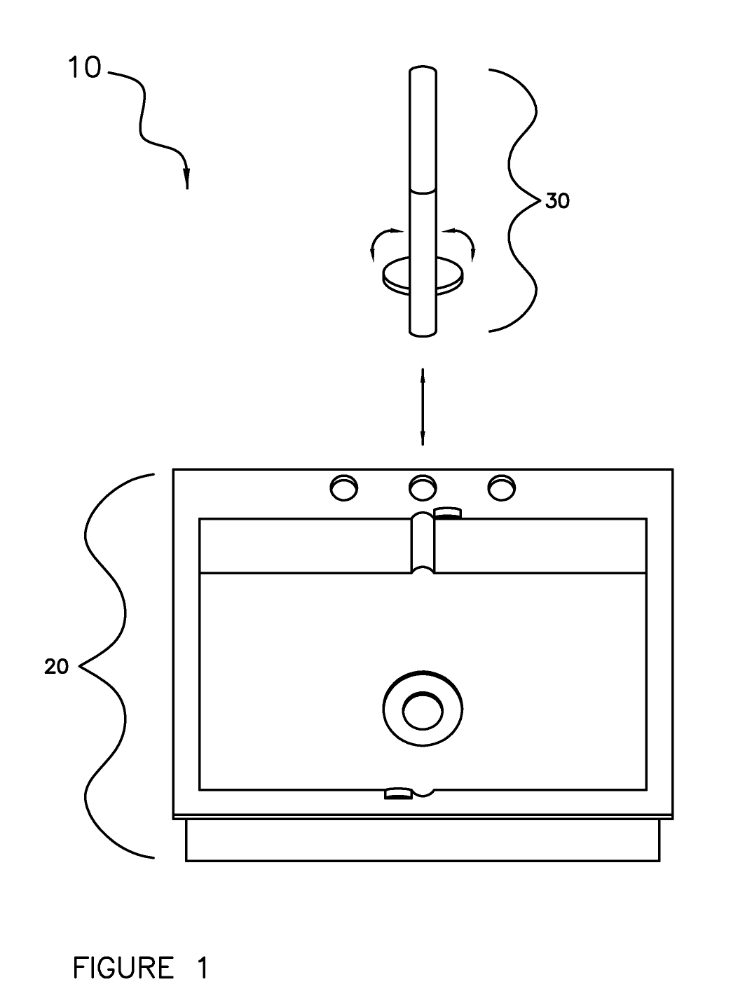

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As will be described below, a sink with removable divider can function as both a single basin sink and a double basin sink depending on the desire of a user. Although described throughout this document as pertaining to a kitchen sink, this is for exemplary purposes only. To this end, the sink described herein can have an unlimited number of uses and commercial applications, and is not intended to be limiting in any manner.

FIG. 1 illustrates an exploded parts view of one embodiment of a sink with removable divider that is useful for understanding the inventive concepts disclosed herein. As shown, the sink can include a sink body 20 having a plurality of channels 25 disposed therein, and a removable divider 30.

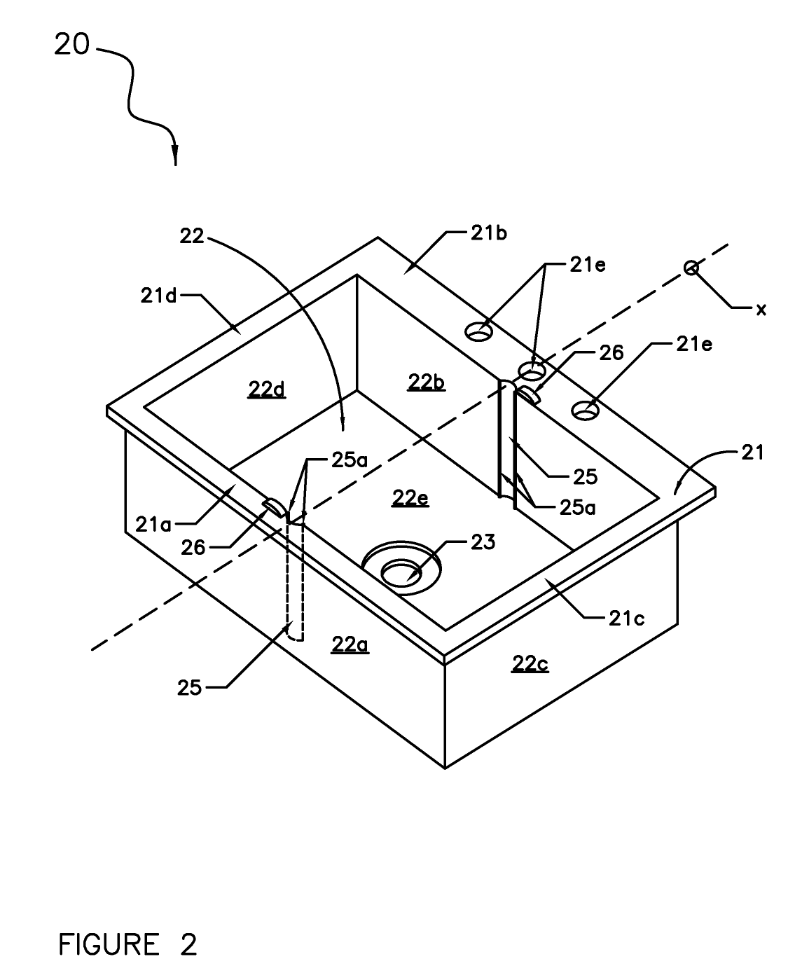

FIG. 2, illustrates one embodiment of a sink body 20. As shown, the sink body can include a lip portion 21 having a front edge 21a that, when installed, faces the user, a rear edge 21b and a pair of side edges 21c and 21d which connect the ends of the front and rear edges together. The lip 21 can also include any number of openings 21e for accommodating faucets, and can function in a traditional manner to provide an anchoring point for securing the sink body 20 to a counter (not shown). As described herein, the lip portion 21 can include any number of different shapes, thicknesses, channels and dimensions so as to allow the sink to be installed as either a drop-in sink with the lip exposed, or as an under-mount sink with the lip hidden beneath the countertop.

The sink basin 22 can include a substantially flat front side wall 22a a substantially flat rear side wall 22b, a pair of opposing side walls 22c and 22d, and a base portion 22e having a drain element 23 disposed therein. In one preferred embodiment, the basin elements 22a-22e can include a unitary construction in accordance with known manufacturing techniques so as to form a smooth continuous waterproof basin. Moreover, it is preferred that the drain 23 include an industry standard circular drain having a diameter of 3.5 inches. Such a feature shall allow the sink and drain elements to function with standard external elements such as garbage disposal systems and/or standard plumbing fixtures, for example. Of course, other embodiments are contemplated having a different shaped or sized drain.

As shown, a pair of opposing channels 25 can be provided along the front and rear walls of the basin 22a and 22b, respectively. The channels can be constructed, substantially, as recesses within the basin walls, or as elements extending outward therefrom and having a recessed middle section for containing the divider. In either instance, the channels are preferably being disposed along the transverse central plane X of the sink body 20 that extends perpendicularly relative to the front portion of the lip 21a and the rear portion of the lip 21b. Each of these channels 25 can be lined with optional gaskets 25a made from an elastomeric material such as rubber, for example, so as to create a watertight seal when the divider 30 is installed within the channels, as described below. Moreover, the sink body can also include one or more locking mechanisms 26, such as a sliding clip or other such device, which can be positioned along one or both of the front and rear lip surfaces so as to prevent the installed divider from moving once installed within the sink.

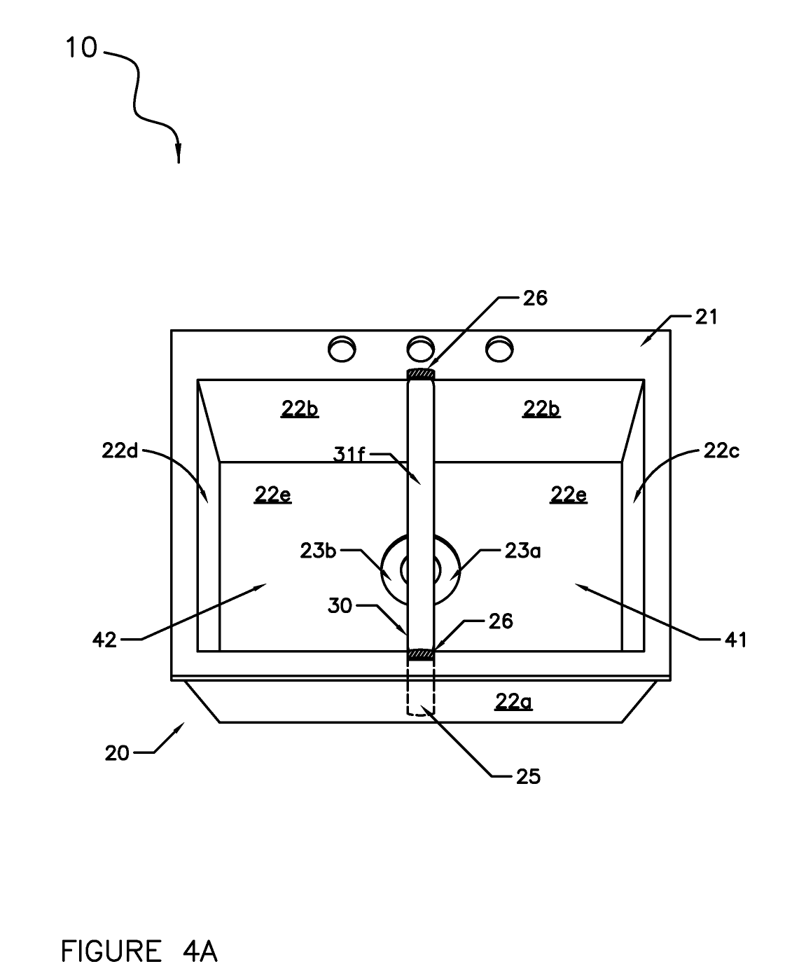

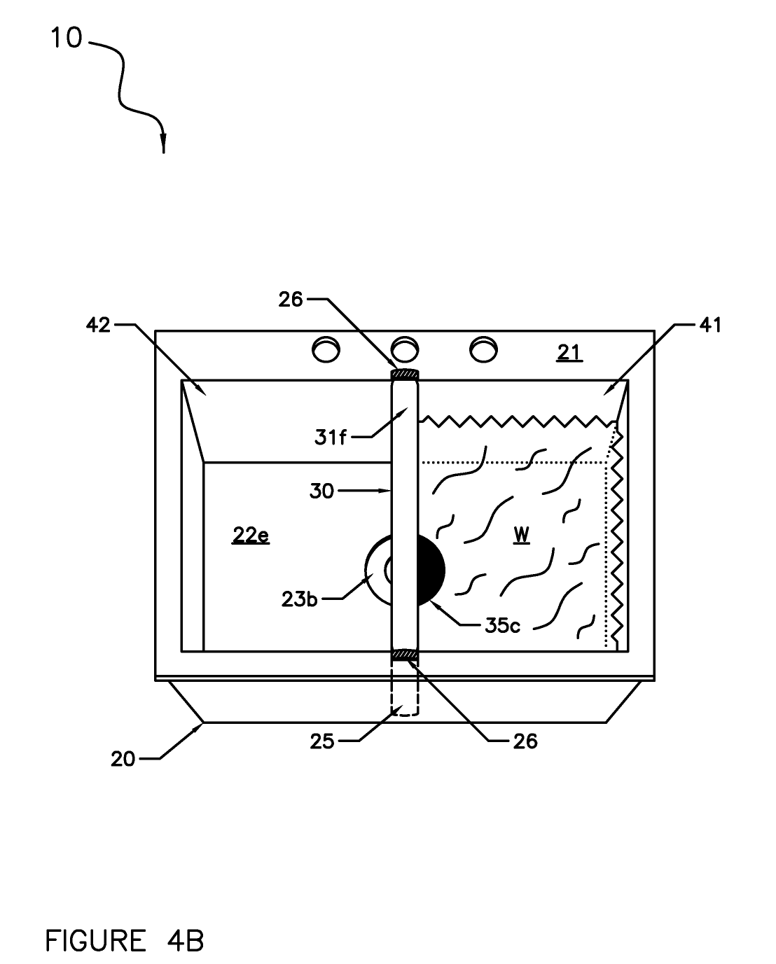

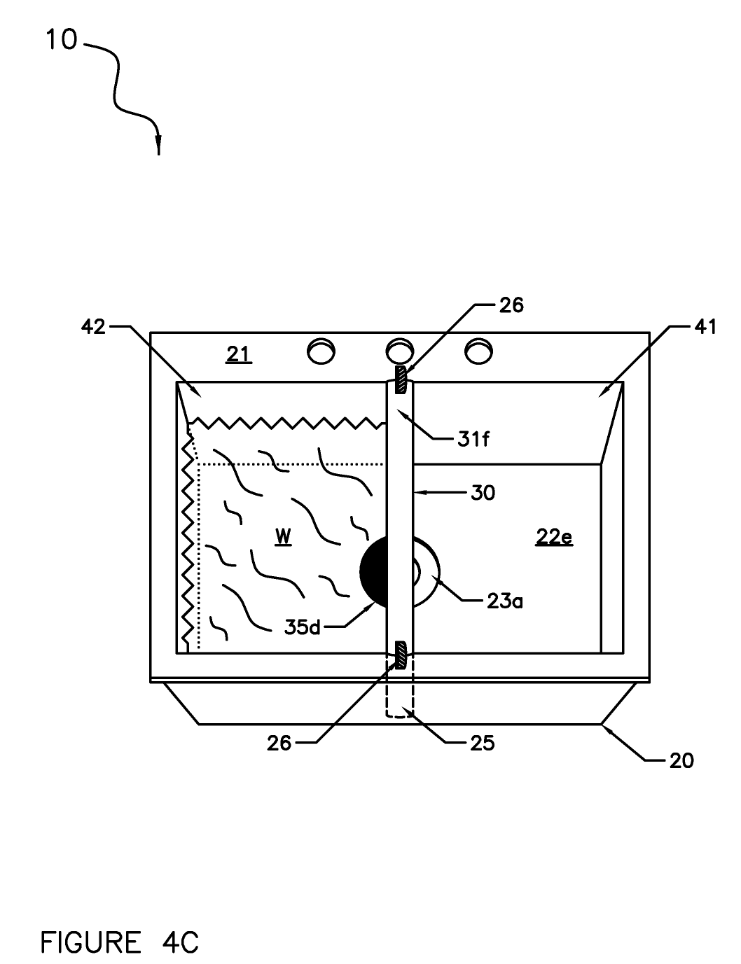

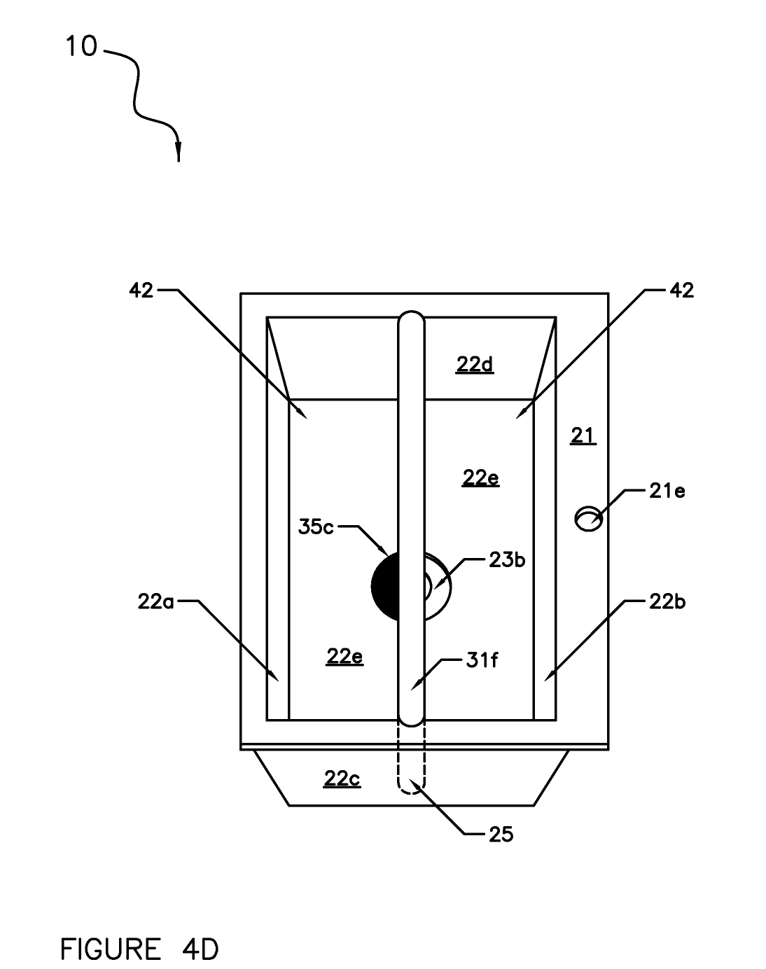

Although described above as positioning the channels along a specific portion of the front and rear walls, the channels can also be positioned at other locations within the sink basin. For example, the channels can also be placed along the opposing side walls, so as to allow the divider to bisect the basin as illustrated in FIG. 4D below. Moreover, although illustrated as including a generally rectangular sink and basin body having separately identified wall sections, this is for illustrative purposes only, as those of skill in the art will recognize that the sink body can take any number of different shapes such as oval and rectangular, for example, and sizes, and can also be constructed from any number of different materials such as steel and ceramic, for example.

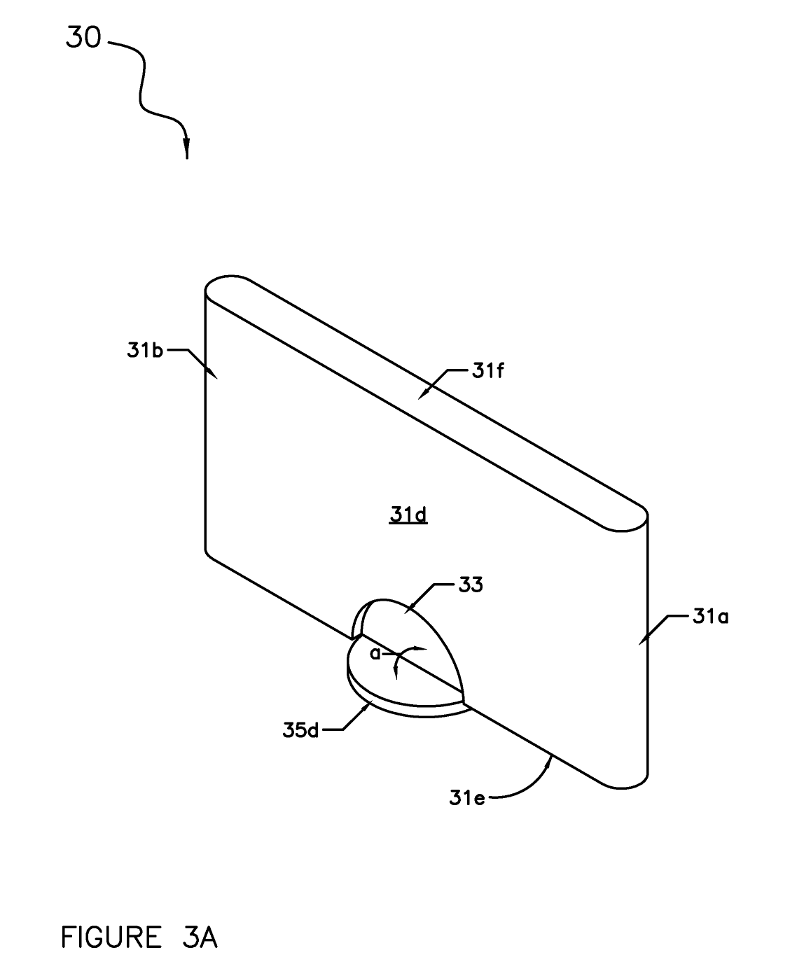

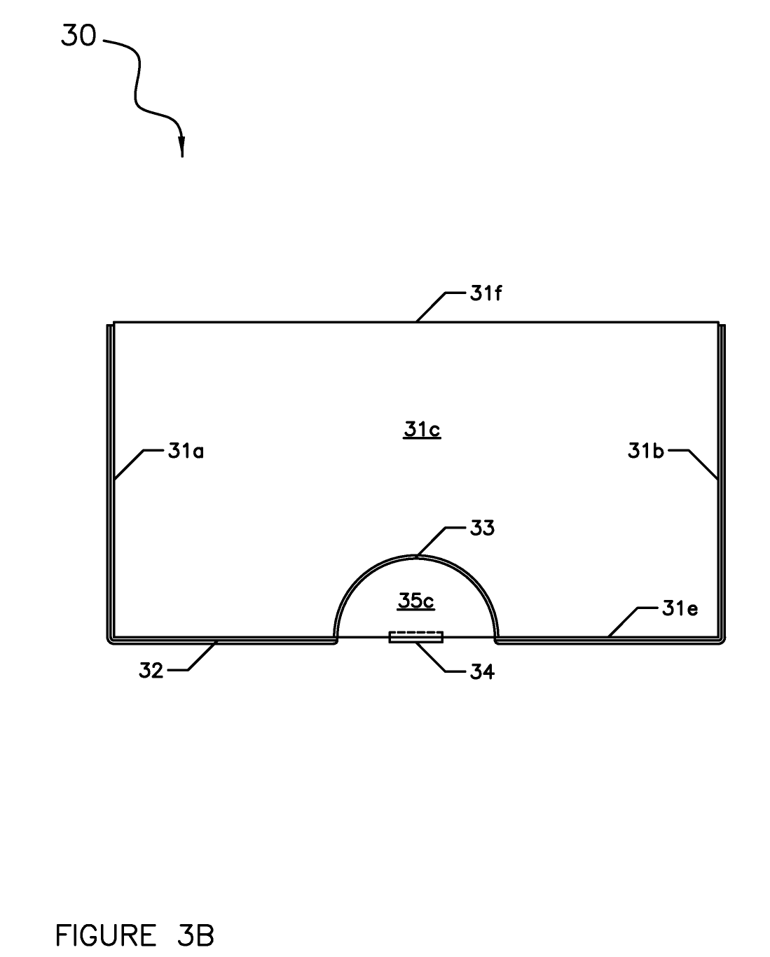

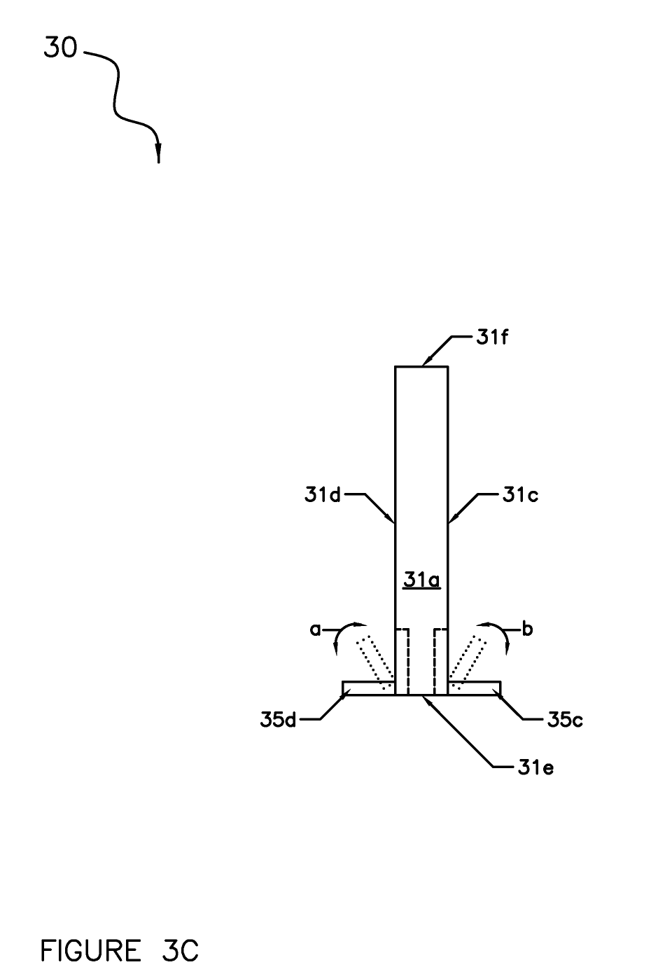

FIGS. 3A-3C illustrate one embodiment of a divider 30 for use with the sink body 20 described above. As shown, the divider can include a main body having a front edge 31a, a rear edge 31b, a pair of opposing side sections 31c and 31d, a bottom edge 31e and a top edge 31f. As described herein, the divider 30 can include complementary shapes and dimensions to the sink basin so as to be inserted within the channels 25 and to extend from the rear wall 22b to the front wall 22a in the preferred embodiment, or the opposing side walls 22c and 22d in the alternate embodiment, while maintaining constant contact with the bottom wall 22e.

In the preferred embodiment, the divider can include a length (i.e., from 31a to 31b) that is approximately the same as the distance between sink walls 22a and 22b; a width (i.e., from 31c to 31d) that is approximately the width of the channels 25 so as to allow insertion therein; and a height (i.e., from 31e to 31f) that is approximately the distance between the basin wall 22e and the lip 21.

In one preferred embodiment, the divider can further include an elastomeric gasket 32 that is preferably constructed from rubber or a rubber-like material can be positioned along one or more of the front, rear and bottom edges of the divider. The gasket functioning to create an impermeable seal between the divider and the sink basin surfaces.

As shown, a pair of recessed cavities 33 can be formed along the bottom edge of each of the side walls 31c and 31d. Each of these cavities can house an articulating drain plug 35c and 35d, respectively that are secured to the divider via a hinge 34 or other articulation device. As indicated by arrows a and b, each of the drain plugs can independently transition (FIG. 3C) between a folded state (FIG. 3B) wherein the plugs 35c and 35d are located within the cavities 33, and an unfolded state (FIG. 3A) wherein the plugs 35c and 35d are not located within the cavities 33.

As described herein, each of the plugs 35c and 35d can function as a barrier to prevent water within the sink basin from draining through the drain 23. In this regard, each of the plugs 35c and 35d can include a shape and dimension that approximates one-half of the shape and dimension of the drain 23, minus the thickness of the divider itself. For example, in one embodiment, the divider 30 can include a thickness of 1.5 inches, and the drain 23 can include a diameter of 3.5 inches. In this example, each of the plugs 35c and 35d can include opposing semicircular elements having a measurement (i.e., diameter) from the side wall of the divider 31c and 31d, respectively of 1 inch.

In one preferred embodiment, the divider 30 can be constructed from a solid non-porous, high density polyethylene material that is waterproof, safe for food handling and resistant to cuts and scrapes. In this regard, when the divider 30 is constructed from such material, the divider can act as a kitchen cutting board which can be cleaned after each use by being positioned within the channels 25 and having water sprayed thereon.

Although described above as including a cutting board, other embodiments are also contemplated. To this end, the divider 30 can be constructed from any number of different materials that are suitable for use in a kitchen environment and that are suitable for long term exposure to water. Several non-limiting examples include stainless steel, aluminum, plastics and composites, among many others, for example.

In one embodiment, each of the drain plugs can be constructed from an identical material as the divider and can be coated with an elastomeric coating that is sufficient to create an impermeable bond between the drain 23 and the plug. Of course, the drain plugs need not be constructed from an identical or substantially identical material as the divider, as the plugs themselves can be constructed wholly or in part from solid pieces of elastomeric material such as rubber, for example, that are also capable of creating the impermeable bond.

Although described above as including articulating plugs, those of skill in the art will recognize that any number of different devices can also be utilized to plug the respective halves of the drain unit. As such, alternate embodiments of the divider 30 can include a solid divider body construction having a pair of separate semicircular stoppers for use therewith. Additional embodiments can also include recesses within the divider body walls to store the separate semicircular stoppers when they are not in use.

FIG. 4A illustrates one embodiment of the device 10 wherein the removable divider 30 has been slidingly positioned into the channels 25 of the sink body 20. When in this position, the locking mechanism(s) 26 can be positioned so as to engage the top edge 31f of the divider along one or both of the front and rear edges of the lip 21. In this regard, the installed divider can function to divide the sink basin into separate compartments 41 and 42, each sharing one-half of the drain 23a and 23b, respectively.

As shown in FIGS. 4B, and 4C, through the combined operation of the plugs 35c and 35d with the gaskets 25a and/or 32, the removable divider 30 can function to create two fully operational sink basins which can be selectively and independently filled with water W and drained, without allowing the water located in one compartment 41 to leak into the other compartment 42, and vice versa. Conversely, when the user desires one large sink basin, the divider can be removed and the sink can function as such.

Although described above as operating with a single drain 23, the inventive concepts disclosed herein can equally be adapted for use in homes that are pre-plumbed with dual kitchen sink drains. In this regard, the single drain element 23 described above can be replaced with two separate drain elements and the divider can include a pair of separate circular drain plugs.

Accordingly, the sink with removable divider 10 described herein functions to allow users to transition between a single and double basin sink in a novel manner that is easy to operate and is cost effective.

As described herein, one or more elements of the sink 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements of each of the sink body 20 and the divider 30, may each be formed together as continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A sink, comprising:
a sink body that includes
a sink basin having a plurality of generally vertical basin walls,
a drain element that is disposed along a generally horizontal bottom wall of the basin,
a pair of channels that are positioned along two of the basin walls at a generally parallel orientation with each other, said channels including a first thickness, and
a lip encompassing a top end of each of the plurality of generally vertical basin walls; and
a divider that includes
a main body having a length that approximates a distance between the pair of channels, and a thickness that approximates the first thickness,
said divider functioning to engage each of the channels so as to create two separate compartments within the sink basin, and
a pair of drain plugs, each functioning to engage a portion of the drain element so as to create a waterproof barrier.

2. The device of claim 1, wherein the channels are positioned within the basin along a front side wall and a rear side wall.

3. The device of claim 1, wherein the channels are positioned along a pair of opposing side walls.

4. The device of claim 1, wherein said divider creates an impermeable barrier between the two compartments.

5. The device of claim 1, wherein the divider further includes a pair of recessed cavities for storing the plugs in a folded state.

6. The device of claim 5, wherein said plugs are hingedly secured to the divider and function to independently transition between the folded state and an unfolded state.

7. The device of claim 1, wherein said divider includes a cutting board that is constructed from a solid non-porous, high density polyethylene material that is waterproof, safe for food handling, and resistant to cuts and scrapes.

8. The device of claim 1, wherein said drain element is located along the bottom wall at a location that is generally transverse to a central plane of the sink body, and includes a circular opening having an approximate diameter of 3.5 inches.

9. The device of claim 8, wherein each of the drain plugs include a semicircular shape, and include an impermeable construction material.

10. The device of claim 1, further comprising:
at least one locking mechanism that is configured to engage a top surface of the divider and to prevent separation of the divider and the sink basin.

11. The device of claim 1, wherein the divider further includes a gasket that is positioned along one or more of a divider edges, said gasket functioning to create an impermeable seal between the divider and the sink basin.

12. The device of claim 1, wherein each of said channels include a gasket, said gasket functioning to create an impermeable seal between the channel and the divider.

13. The device of claim 1, wherein the lip includes a shape and dimension suitable for mounting the sink to a counter in an undermount manner.

14. The device of claim 1, wherein the lip includes a shape and dimension suitable for mounting the sink to a counter in a drop-in manner.

15. A sink, comprising:
a sink basin having a front wall, a back wall, a first side wall, a second side wall, and a bottom wall;
a drain element that is disposed along the bottom wall;
a lip encompassing a top end of each of the front wall, the back wall, the first side wall and the second side wall; and
a pair of generally vertical, generally parallel channels that are positioned along the front and back walls, said channels functioning to receive a divider that is configured to create two separate compartments within the sink basin.

16. A divider that is positionable within a sink having a pair of generally parallel channels located within a sink basin, and a drain element, said divider comprising:
a main body having a length that approximates a distance between a front wall and a back wall of the sink basin, a height that approximates a distance between a bottom wall and a lip of the sink basin,
said divider functioning to engage each of the channels so as to create two separate compartments within the sink basin; and
a pair of drain plugs, each functioning to engage a portion of the drain element so as to create a waterproof barrier.

17. The divider of claim 16, further comprising:
a pair of recessed cavities for storing the plugs in a folded state.

18. The device of claim 17, wherein said plugs are hingedly secured to the divider and function to independently transition between the folded state and an unfolded state.

19. The device of claim 18, wherein said unfolded state includes positioning one of the gaskets along the drain element so as to create an impermeable barrier.

20. The device of claim 1, wherein said divider includes a cutting board that is constructed from a solid non-porous, high density polyethylene material that is waterproof, safe for food handling, and resistant to cuts and scrapes.
